(19) United States
(12) Patent Application Publication
(10) Pub. No.: US 2015/0367175 A1
(43) Pub. Date: Dec. 24, 2015

(54) SYSTEM USABLE BY A USER FOR TRAINING, METHOD FOR TRAINING AND RELATED PROGRAM PRODUCT

(71) Applicant: TECHNOGYM S.P.A., Gambettola, FORLI'-CESENA (IT)

(72) Inventors: Nerio ALESSANDRI, Cesena, FORLI'-CESENA (IT); Alessandro PASINI, Cesena, FORLI'-CESENA (IT)

(21) Appl. No.: 14/762,418

(22) PCT Filed: Dec. 18, 2013
(86) PCT No.: PCT/IB2013/061061

§ 371 Date: Jul. 21, 2015

(30) Foreign Application Priority Data
Jan. 24, 2013 (IT) MI2013A000110

(51) Int. Cl. A63B 24/00; A63B 22/02; A63B 23/04; G09B 19/00

(52) U.S. Cl. CPC A63B 24/0075; G09B 19/0038; A63B 22/02; A63B 23/0405; A63B 24/0006; A63B 2024/0015

(57) ABSTRACT

A system usable by a user for training that includes a data processing unit, a memory unit operatively connected to the data processing unit, and an electronic camera device operatively associated to the data processing unit. The electronic camera device is configured to acquire one or more digital images representing the user, and the one or more digital images are a sequence of digital images representing the user's body movement during training. The data processing unit is configured to provide the user, based on the sequence of digital images representative of the user's body movement during training, with information representing biophysical feedback on the training of the user.

The present invention relates to the fitness sector and, in particular to a system usable by a user for training, a method for training and related program product.

Nowadays, the training of a user on a gymnastic machine is typically supervised by specialised gym staff (personal trainers). The technological evolution of gymnastic machines is leading to a reduction of the direct assistance of personal trainers, at least as regards pre-training assistance. For example, the instructions for using and/or configuring a gymnastic machine before training may be used by the user by means of a display which the control panel of the gymnastic machine is equipped with, for example playing a video clip illustrating such instructions.

However, as regards assistance during or after training the presence of a personal trainer is still in most cases essential, for example to provide the user with instructions on how to perform a specific exercise or in general the training (in the case, for example, of running, walking or pedaling).

Such instructions, by a personal trainer, are even more important in the case of users with specific rehabilitation programs or in the case of utilisation of a particularly sophisticated gymnastic machine or in general gymnastic machine by a user.

However, the constant presence of a personal trainer alongside the user entails significant costs both for the gym and for the user.

Consequently, a need is strongly felt to be able to avail of gymnastic machines or more generally of training systems which are increasingly able, even if only partially, to assist a user independently without the need for specialised staff to be present.

The purpose of the present invention is to provide a system usable by a user for training and a method for training which makes it possible to overcome the drawbacks mentioned above with reference to the prior art.

Such purpose is achieved by a system usable by a user for training according to claim 1.

The present invention also relates to a method for training according to claim 18 and a program product according to claim 25.

Further characteristics and advantages of the training system and method for training according to the invention will, in any case, be evident from the description given below of its preferred embodiments, made by way of a non-limiting example with reference to the appended drawings, wherein:

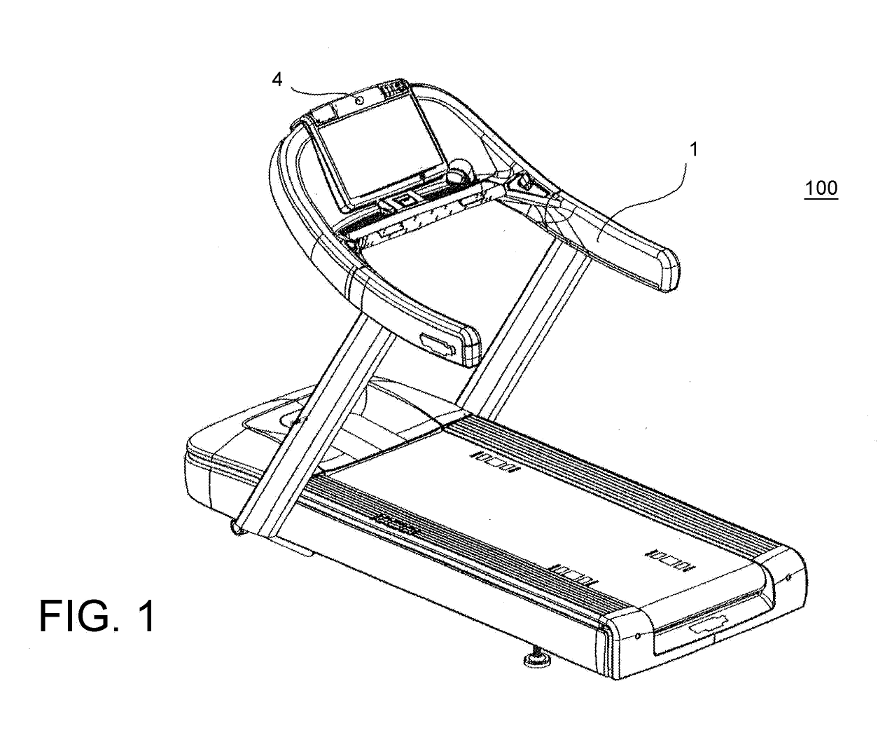

FIG. 1 shows a schematic view of a gymnastic machine usable in a training system according to one embodiment of the invention;

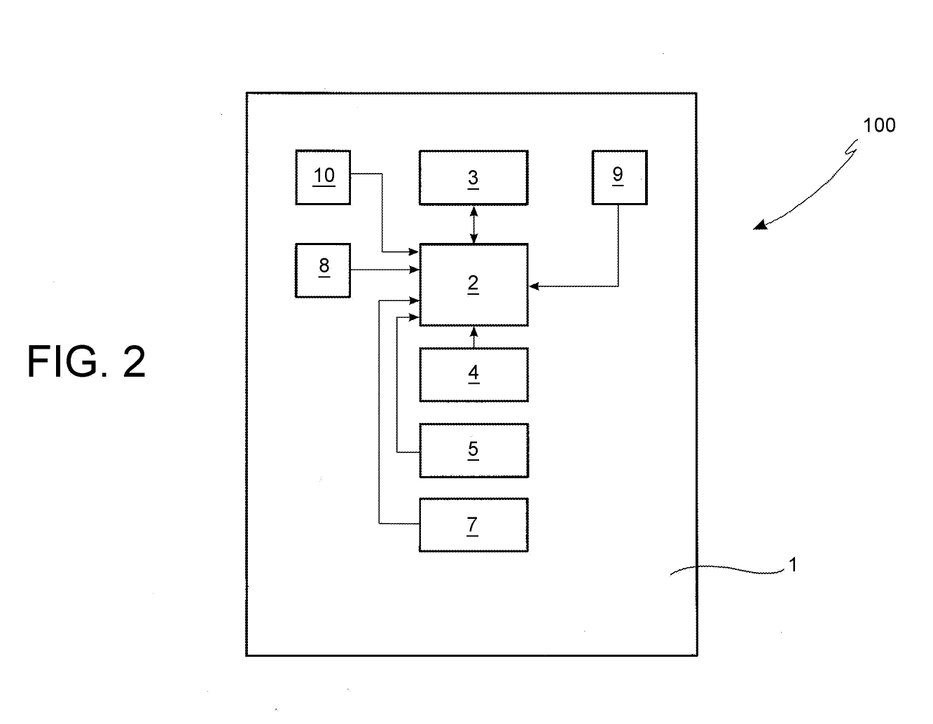

FIG. 2 shows a block diagram of a training system according to a further embodiment of the invention;

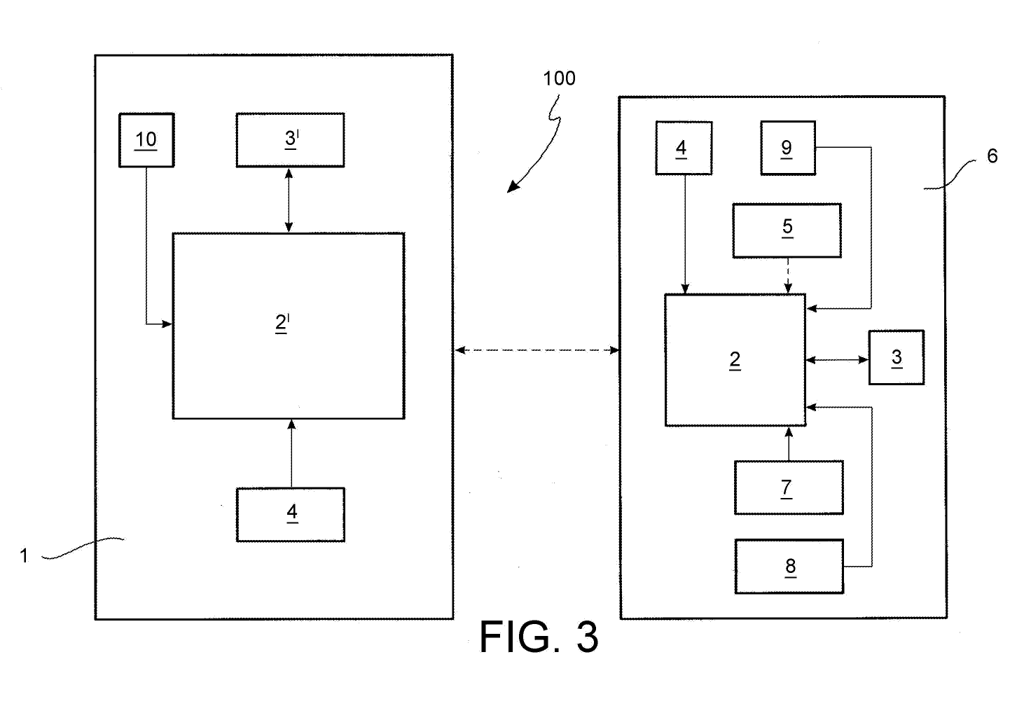

FIG. 3 shows a block diagram of a training system according to a further embodiment of the invention, and

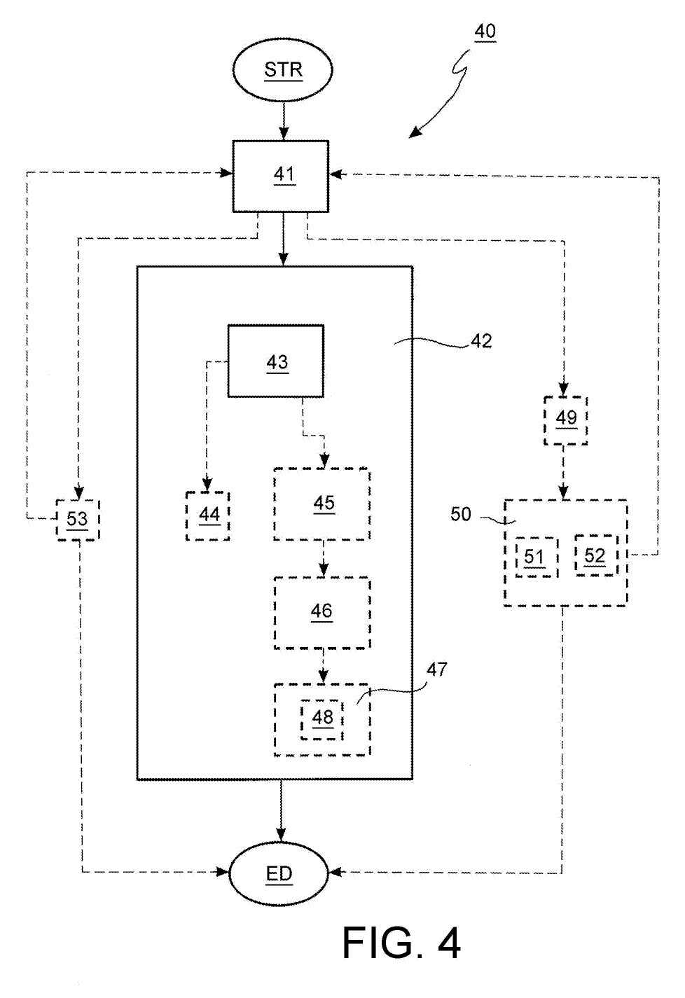

FIG. 4 shows a block diagram to schematically illustrate a method for training according to one embodiment of the invention.

With reference to the aforementioned figures, a system usable by a user for training according to the present invention will now be described.

It is to be noted that, in the drawings, the same or similar elements are denoted using the same reference numerals.

The training system, hereinafter also system, is globally denoted by reference numeral 100 in the drawings.

With particular reference to the embodiment in FIG. 2, the system 100 comprises a data processing unit 2, for example a micro processor or a micro controller, and a memory unit 3, operatively connected to the data processing unit 2. The memory unit 3 may be internal or external (as shown in FIG. 2) to the data processing unit 2.

In addition, the system 100 comprises an electronic camera device 4 operatively associated to the data processing unit 2.

The electronic camera device 4 is configured to acquire one or more digital images representative of the user. Examples of the aforesaid electronic camera device 4 are a webcam, video camera and so forth.

According to one embodiment, such one or more images representative of the user acquirable by the electronic camera device 4 are a sequence of digital images representative of the user's body movement during training.

In greater detail, such one or more images representative of the user are preferably a sequence of digital images representative of movement of an upper portion of the user's body (for example the head or chest), upper body portion which during training is situated substantially in front of the electronic camera device 4.

In the case of FIG. 1, where the training performed by the user is running or walking on a treadmill (shown schematically in the figure), the user's body movement during training is for example the movement of the head, in relation to a point of reference, while walking or running on the treadmill. The head movement, performed repetitively more or less regularly, may be a lateral movement towards the right or left or an upward or downward movement in relation to the point of reference. Such point of reference may be, as will be confirmed below, for example the nose (in the case of the head).

In this embodiment, the data processing unit 2 is configured to provide the user, based on the sequence of digital images representative of the user's body movement, with information representing biophysical feedback on the user's training.

It is to be noted that user training is understood to mean both the training performed (that is to say performed and completed) by the user and the training in progress (that is to say being performed).

In greater detail, the data processing unit 2 may be configured to process, using a respective program code, the sequence of digital images provided by the electronic camera device 4 to provide the aforesaid information representing biophysical feedback of the training performed by the user.

In the case in which training consists of running or walking on the treadmill (shown in FIG. 1), the data processing unit 2 is configured to provide the user biophysical feedback, based on the sequence of digital images provided by the electronic camera device 4, such as an indication of the presence or not of asymmetries between the right and left sides of the body when running or walking.

For example, this may be achieved by the data processing unit 2, by detecting in the sequence of digital images provided by the electronic camera device 4, a lateral inclination of the user's head and/or, more generally, of the user's chest while running or walking.

It is to be noted that the indication of the presence or not of asymmetries between the right side and the left side of the body while running or walking advantageously provides the user with an assessment of the symmetry of his posture during training without the necessary presence of a personal trainer.

According to another embodiment, the data processing unit 2 is configured to determine, based on the sequence of digital images provided by the electronic camera device 4, information representing a time interval elapsing between two consecutive impacts of the user's feet on the treadmill while running or walking.

In greater detail, the data processing unit 2 is configured to determine, in the sequence of digital images provided by the electronic camera device 4, a point of reference integral with the upper body portion within an image acquired by the electronic camera device 4.

In the case in which the upper body portion is for example the head, the point of reference is preferably the centre of the face, for example, as mentioned previously, the nose.

In addition, the data processing unit 2 is configured to generate a first substantially periodic signal representative of a first deviation from the point of reference in a vertical direction in relation to a reference plane, for example the plane represented by the treadmill or the plane which the treadmill or in general the gymnastic machine 1 lies on.

The first deviation of the point of reference represents a first deviation in time of the user's head in a vertical direction (in other words, upwards or downwards) in relation to the reference plane, while running or walking.

In addition, the data processing unit 2 is moreover configured to generate a second substantially periodic signal representative of a second deviation from the point of reference in a horizontal direction in relation to a reference plane, for example the plane represented by the treadmill or the plane which the treadmill or the gymnastic machine 1 lies on.

The second deviation of the point of reference represents a second deviation in time of the user's head in a horizontal direction (in other words, towards the right or towards the left) in relation to the reference plane, while running or walking.

The data processing unit 2 is moreover configured to determine, based on the first substantially periodic signal and/or the second substantially periodic signal, the time interval elapsing between two consecutive impacts of the user's feet (right and left or vice versa) on the treadmill. This can be obtained by calculating the time interval between two consecutive peaks of the first substantially periodic signal or of the second substantially periodic signal.

Based on the time interval elapsing between two consecutive impacts of the user's feet, the data processing unit 2 is able to provide the user, for example by means of a message visualised on a display screen operatively associated to the gymnastic machine 1 or by means of a vocal message, with information representing the frequency (or pace) of running or stepping while running or walking.

According to other embodiments, combined with or alternative to that just described, the data processing unit 2 may be configured to determine the time interval elapsing between two consecutive impacts of the user's feet (right and left or vice versa) on the treadmill, on the basis of other substantially periodic signals over time, generated by the data processing unit 2 starting from electric signals received from other electronic devices which may be operatively associated to the data processing unit 2.

For example, the electric signal may be an electric signal representing the noise generated by the impact of the user's feet picked up by a microphone associated to the data processing unit 2, as will be described below.

In this example, the peaks of the electric signal representing the noise represent the instants in which the impact of the feet on the treadmill takes place. The data processing unit 2 is able to determine, based on the time interval between consecutive peaks of the electric signal representing the noise, the time interval elapsing between two consecutive impacts of the user's feet (right and left or vice versa) on the treadmill.

In addition, the data processing unit 2 is configured to determine, based on the amplitude of the peaks of the electric signal representing the noise, the entity of the impact of the right foot and of the left foot. Based on the entity of the impact of the right foot and of the left foot determined, the data processing unit is configured to provide the user, as further biophysical feedback, with information representing any asymmetries in the impact force of the user's feet on the treadmill. It is to be noted that a user pressing on one foot more than the other presents an incorrect running method and it is therefore useful to provide the user with such further biophysical feedback so that he can see how to correct his running or walking posture.

In another example, the electric signal may be an electric signal representing an electric current absorbed by an electric motor which the treadmill or in general the gymnastic machine 1 is equipped with, suitable to operate the treadmill, detected by an electric current sensor which the treadmill or in general the gymnastic machine 1 is equipped with. As also described further below, the electric current sensor is operatively connected to the data processing unit 2.

In this further example, the peaks of the electric signal representing the electric current absorbed represent the instants in which the impacts of the feet on the treadmill take place. In fact it is to be noted that the impact of the user's feet on the treadmill has a “braking” effect which causes a peak in the electric current absorbed by the electric motor. The data processing unit 2 is able to determine, based on the time interval between consecutive peaks of the electric signal representing the electric current absorbed, the time interval elapsing between two consecutive impacts of the user's feet (right and left or vice versa) on the treadmill.

In this case too, the data processing unit 2 is configured to determine, based on the amplitude of the peaks of the electric signal detected representing the electric current absorbed, the entity of the impact of the right foot and of the left foot. Based on the entity of the impact of the right foot and of the left foot determined, the data processing unit is configured to provide the user, as further biophysical feedback, with information representative of any asymmetries in the impact force of the user's feet on the treadmill. It is to be noted that a user pressing on one foot more than the other presents an incorrect running method and it is therefore useful to provide the user with such further biophysical feedback so that he can see how to correct his running or walking posture.

In another example, the electric signal may be an electric signal representing the vibrations of the treadmill or of the gymnastic machine 1 in general detected by an accelerometer operatively associated to the data processing unit 2, as will be described below.

It is to be noted that, for example one or more accelerometers may be attached to the treadmill or to a portion of the frame of the gymnastic machine. In another example, an accelerometer suitable for this function may be that which a portable electronic device of the user is fitted with associated (for example, laid) on the gymnastic machine 1.

In this case too, the data processing unit 2 is in addition configured to determine, based on the amplitude of the peaks of the electric signal detected representing the vibrations of the treadmill or of the gymnastic machine 1 in general, the entity of the impact of the right foot and of the left foot. Based on the entity of the impact of the right foot and of the left foot determined, the data processing unit 2 is configured to provide the user, as further biophysical feedback, with information representative of any asymmetries in the impact force of the user's feet on the treadmill. It is to be noted that a user pressing on one foot more than the other presents an incorrect running method and it is therefore useful to provide the user with such further biophysical feedback so that he can see how to correct his running or walking posture.

These and other electronic devices which may be operatively associated to the data processing unit 2 will be described below with reference to further embodiments of the system 100.

Returning to the last example described, the peaks of the electric signal detected representing the vibrations of the treadmill or of the gymnastic machine 1 in general, represent the instants in which the impact of the feet on the treadmill takes place.

In fact it is to be noted that the impact of the user's feet on the treadmill creates a peak in the vibrations of the gymnastic machine. The data processing unit 2 is able to determine, based on the time interval between consecutive peaks of the electric signal detected representing the vibrations, the time interval elapsing between two consecutive impacts of the user's feet (right and left or vice versa) on the treadmill.

According to a further embodiment, in the case in which the training consists of running or walking on a treadmill, the data processing unit 2 is configured to provide the user from the sequence of digital images provided by the electronic camera device 4, based on the scroll speed of the treadmill, with information representing a biophysical feedback on the user's training, for example the stride and/or the width and/or frequency of the step when running or walking.

To such purpose, as described further below, in one embodiment of the system 100, the scroll speed of the treadmill may be acquired by the data processing unit from the treadmill (or in general the gymnastic machine 1) as an exercise parameter set by the user and known to the treadmill, for example in the case in which the data processing unit 2 is integrated into the treadmill. According to another embodiment of the system 100, the scroll speed may instead by supplied manually to the data processing unit 2 by the user, for example in the case in which a portable electronic device (described below) is used, operatively associated to the treadmill and thus to the data processing unit 2 integrated in the gymnastic machine.

It is to be noted that stride is taken to mean the distance (in metres) between two consecutive impacts of the same foot (right, for the right stride or left, for the left stride).

In addition, it is to be noted that width of step (or simply step) is understood to mean the spatial distance (in metres) between two consecutive impacts of the feet. In the case in which the distance between the impact of the right foot and the subsequent impact of the left foot is measured, the width of step corresponding to the left leg is determined. In the case instead in which the distance between the impact of the left foot and the subsequent impact of the right foot is measured, the width of step corresponding to the right leg is determined.

Frequency of step means instead the time interval between two consecutive impacts of the feet, that is to say the pace.

In greater detail, the data processing unit 2 of the gymnastic machine 1 is configured, for example, to calculate the stride based on the scroll speed of the treadmill and time interval between two peaks, separated from each other by only one other peak, of the first substantially periodic signal or of the second substantially periodic signal, described above. In fact, over time, having for example four consecutive peaks of the first substantially periodic signal or of the second substantially periodic signal, the first and third peak are representative of the impact of one of the feet (right or left) while the second and fourth peak are representative of the impact of the other foot (left or right).

Consequently, The data processing unit 2 is configured to determine the user's stride (distance) while running or walking based on the time interval between two consecutive impacts of the same foot (time) and on the basis of the scroll speed of the treadmill (speed).

It is to be remembered that as described further below, in one embodiment of the system 100, the scroll speed of the treadmill may be acquired by the data processing unit from the treadmill (or in general the gymnastic machine 1) as an exercise parameter set by the user and known to the treadmill, for example in the case in which the data processing unit 2 is integrated into the treadmill. According to another embodiment of the system 100, the scroll speed may instead by supplied manually to the data processing unit 2 by the user, for example in the case in which a portable electronic device (described below) is used, operatively associated to the treadmill and thus to the data processing unit 2 integrated in the gymnastic machine.

As regards the width of step (or merely step), the data processing unit 2 is configured to determine the width of step based on the time interval between two consecutive peaks of the first and/or of the second substantially periodic signal and on the scroll speed of the treadmill.

It is to be noted that the second substantially periodic signal further enables the data processing unit 2 to recognise whether an impact refers to the right foot or to the left foot in that such second substantially periodic signal is representative of the lateral movement of the user while running or walking. This way, the data processing unit 2 of the gymnastic machine 1 is able to determine if a stride is the right or left and if the width of step is the right or left.

According to a further embodiment, based on the frequency of the step and/or of the stride and/or of the width of the step, the data processing unit 2 is configured to provide the user with an assessment of his running technique. This can be achieved through the use of a respective program code by the data processing unit 2 based on biomechanical scientific data and on anthropometric user data (height, lever length and so forth).

In fact, the frequency of step, stride and/or width of step is greatly influenced by the user's physical features (physique and anthropometric features).

For example, a tall user, with long levers, generally has a long stride, while a user with a short or normal physique, with short levers, generally has a shorter stride with a greater number of steps.

The data processing unit 2, after acquiring the user's physical characteristics, is configured to provide biofeedback on the correctness of the user's running or walking technique based on the frequency of the step and/or stride and/or width, of step provided, for example, indicating on a display screen (described below) operatively associated to the data processing unit 2 the message “correct technique” or by means of a vocal message of “correct technique” in the case of performance by the user of a natural movement compatible with the physical structure acquired.

According to other embodiments, combined with or alternative to that just described, the data processing unit 2 May be configured to determine the time interval elapsing between two consecutive impacts of the same foot on the treadmill, on the basis of other substantially periodic signals over time, generated by the data processing unit 2 starting from electric signals received from other electronic components with which the gymnastic machine 1 described above may be equipped.

According to one embodiment, such one or more images representative of the user acquirable by the electronic camera device 4 may be in addition a digital image identifying the user.

By way of example, such digital image identifying the user may be an image of the user's face.

In another example, such digital image identifying the user may be a numerical or alphanumerical code, a single dimension barcode or two dimensional barcode (QR Code) and so forth, which the user wears on a garment (for example a bracelet or a sweat band) or which the user displays on the display of a personal portable electronic device, for example a smartphone or a tablet.

In this embodiment, the data processing unit 2 is configured to receive the digital image identifying the user acquired by the electronic camera device 4.

The data processing unit 2 is configured to identify the user based on the digital image identifying the same and to connect itself, for example via Internet, with a remote server (not shown in the drawings) to download, for example on the gymnastic machine. 1 or on the user's portable electronic device, information representing the training of the user identified, for example information relative to the setting up of the gymnastic machine 1 for performance of the training.

Consequently, the presence of the electronic camera device 4 advantageously permits a user to be identified before performing training even in the absence of a personal portable electronic device (for example smartphone or tablet) typically used to identify a user on a gymnastic machine or in general in a gym.

It is to be noted in addition that in the case in which the digital image identifying the user is an image of the user's face, the data processing unit 2 is configured to identify the user by means of a facial recognition program code, which the data processing unit 2 is equipped with.

According to a further embodiment, to be considered alternatively or in addition to that described above, such one or more images representative of the user acquirable by the electronic camera device 4 is a sequence of digital images representing the user during training for connection in real time (for example via Skype) with other users in video calling over the Internet, to which the data processing unit 2 is operatively connected.

This advantageously permits a user to be available while performing training even in the absence of a personal portable electronic device (for example smartphone or tablet) typically used for video calling over the Internet.

According to one embodiment (FIG. 2 or FIG. 3), the system 100 comprises a gymnastic machine 1 usable by a user for training, operatively associated to the data processing unit 2.

For the purposes of the present invention gymnastic machine is taken to mean any machine usable by a user to perform physical exercise (whether training or rehabilitation) such as for example, in the cardio-circulatory sphere, a treadmill, an exercise bike with reclined seat, a standard exercise bike, or, in the weight-training sphere, any weight training equipment, and so forth.

In FIG. 1 the gymnastic machine 1 illustrated is a treadmill. Such choice should not be interpreted as a limitation of the scope of the invention which, on the contrary, may be advantageously applied to any type of gymnastic machine, as defined above.

According to a further embodiment (FIG. 3), the system 100 further comprises a portable electronic device 6 operatively associable to the gymnastic machine 1.

The user's portable electronic device 6, such as a smartphone or tablet, is associable to the gymnastic machine 1 by means of a wired connection (for example, via a docking station) or by means of a wireless connection (for example a Bluetooth type connection).

The portable electronic device 6 is operatively connected to the data processing unit 2.

Returning in general to the system 100, it further comprises a user interface or console 5, for example of the touchscreen type, operatively associated to the data processing unit 2.

In addition, the system 100 comprises a display screen 7 operatively associated to the data processing unit 2.

It is to be noted that in some embodiments, in the case in which the user interface 5 is of the touchscreen type it may coincide with or represent a portion of the display screen 7.

In the embodiment in FIG. 2, the user interface 5 is integrated in the gymnastic machine 1.

According to one embodiment (FIG. 2), the display screen 7 is integrated in the gymnastic machine 1. As said above, the user interface 5 and the display screen 7 may coincide.

According to a further embodiment (shown in FIG. 3), the user interface 5 is integrated in the portable electronic device 6.

According to a further embodiment (FIG. 3), the display screen 7 is integrated in the user's portable electronic device 6. As said above, the user interface 5 and the display screen 7 may coincide even in the case in which they are integrated in the portable electronic device 6.

Returning in general to the system 100, it further comprises at least one accelerometer 8 operatively associated to the data processing unit 2.

According to one embodiment (FIG. 2), the at least one accelerometer 8 is integrated in the gymnastic machine 1.

According to a further embodiment (FIG. 3), the at least one accelerometer 8 is integrated in the user's portable electronic device 6.

Again, the system 100 further comprises in general a microphone 9 operatively associated to the data processing unit 2.

According to one embodiment (FIG. 2), the microphone 9 is integrated in the gymnastic machine 1.

According to a further embodiment (FIG. 3), the microphone 9 is integrated in the user's portable electronic device 6.

With reference to one embodiment (FIG. 2 or FIG. 3), the gymnastic machine 1 may further comprise an electronic sensor 10 of electric current, operatively associated to the data processing unit 2, configured to detect the electric current absorbed by an electric motor which the gymnastic machine 1, for example a treadmill, is equipped with, during training by the user.

In greater detail, the electronic sensor 10 of electric current 10 is integrated in the gymnastic machine 1.

With reference now to the embodiment in FIG. 2, it is to be noted that the electronic camera device 4 may also be integrated in the gymnastic machine 1 (as also illustrated in FIG. 1).

According the embodiment in FIG. 3, the electronic camera device 4 may also be integrated in the user's portable electronic device 6.

According to one embodiment (FIG. 2), in combination with those previously described, the data processing unit 2 and the memory unit 3 are integrated in the gymnastic machine 1.

It is to be noted that according to a further embodiment (not shown), the data processing unit 2 is configured to send information to the user's portable electronic device 6, such as, for example information representing biophysical feedback on the user's training.

According to another embodiment (FIG. 3), alternative to the previous and in combination with the others previously described, the data processing unit 2 and the memory unit 3 are integrated in the user's portable electronic device 6.

It is to be noted that in this embodiment, the gymnastic machine 1 comprises a further data processing unit 2′ and a further memory unit 3′ operatively associated thereto. The further data processing unit 2′ is configured to send information to the data processing unit 2 of the user's portable electronic device 6, such as, for example, information representing the electric current absorbed by the electric motor of the gymnastic machine 1 detected by the electronic sensor 10 of electric current which the gymnastic machine 1 is fitted with (if present) or the scroll speed of the treadmill.

To such purpose, the scroll speed of the treadmill may instead by supplied manually by the user to the data processing unit 2 by means of the portable electronic device.

In a further embodiment, not shown, the electronic camera device 4 may be integrated in the gymnastic machine 1 and the data processing unit 2 may be integrated in the user's portable electronic device 6. In this embodiment also, the gymnastic machine 1 comprises a further data processing unit 2′ configured to send to the data processing unit 2 of the user's portable electronic device 6, one or more digital images representative of the user acquired by the electronic camera device 4.

In a further embodiment, not shown in the drawings, the data processing unit 2 is integrated in the gymnastic machine 1 and the user interface 5 (and possibly also the display screen 7) is integrated in the user's portable electronic device 6. In this embodiment, the portable electronic device 6 comprises a further data processing unit (and a further memory unit connected thereto) configured to send information to the data processing unit 2 integrated in the gymnastic machine 1, such as for example the scroll speed of the treadmill which may be entered manually by the user by means of the user interface 5 of the portable electronic device 6 or which may be acquired by the data processing unit (integrated in the gymnastic machine 1) as an exercise parameter known to the gymnastic machine 1.

It is to be noted that, as well as the embodiments described, other embodiments may exist which provide for the combination of the electronic devices described so far integrated either in the gymnastic machine 1 (where possible) or in the portable electronic device (where possible) or in both.

With reference again to the figures, an example of functioning of the system 100 usable by a user for training according to one embodiment of the invention (FIG. 2) will now be described.

A user goes to the gymnastic machine 1 (treadmill) to train. By moving a bracelet provided with QR code towards the machine, the electronic camera device 4 acquires a digital image identifying the user.

The data processing unit 2 identifies the user based on the digital image identifying the user acquired by the electronic camera device 4, connects to a remote server via Internet and downloads the information needed to set up the machine 1 for the user identified.

The user then commences training.

During training the user may activate a Skype connection by means of the user interface 5 for example integrated in the gymnastic machine 1, to make or receive a video call so as to converse with another user. By acquiring the sequence of digital images representing the user in real time the electronic camera device 4 permits the user to make the video call while training.

During training, while running or walking the electronic camera device 4 acquires a sequence of digital images representing the user's body movements (in the case of a treadmill, his posture).

The data processing unit 2 of the gymnastic machine 1, based on such sequence of digital images provides the user with information representing biophysical feedback on the training in progress or carried out by the user, for example indicating to the user any asymmetries present between the right side and the left side of the body.

In addition, the data processing unit 2 of the gymnastic machine 1, based on the sequence of digital images representing the user acquired by the electronic camera device 4, determines information representing a time interval elapsing between two consecutive impacts of the user's feet on the treadmill. On the basis of this information and on the scroll speed of the treadmill, the data processing unit 2 of the gymnastic machine 1 determines and informs the user for example by means of a message displayed on the display screen 7 of the gymnastic machine 1 or by means of a vocal message, of the user's stride or width of step during training.

It is to be noted that the scroll speed of the treadmill may be acquired by the data processing unit 2 from the treadmill as an exercise parameter set by the user and known to the treadmill, in the case in which the data processing unit 2 is integrated in the treadmill, or may be provided manually by the user in the case in which the user's portable electronic device 6 operatively associated to the treadmill and thus to the data processing unit 2 integrated in the gymnastic machine 1 is used.

In one embodiment, based on the frequency of the step and of the stride or width of the user's step, the data processing unit 2 is configured to provide the user with an assessment of his running technique, for example indicating on the display screen 7 which the gymnastic machine 1 is fitted with, the message “correct technique” in the case of performance of a natural movement by the user.

With reference to FIG. 4, a training method 40 for a user will now be described,

Reference will be made henceforth to the components of the system 100 described above in as general a manner as possible and also according to the possible embodiments.

The training method 40 of a user on a gymnastic machine 1, hereinafter simply method 40, comprises a symbolic step of starting STR.

Subsequently, the method 40 comprises a step of acquiring 41, by an electronic camera device 4 operatively associated to a data processing unit 2, one or more digital images representing the user.

It is to be noted that in the description of the aforesaid method, a data processing unit 2 is understood as that which may be provided either on the gymnastic machine 1, in one embodiment of the system 100 (FIG. 2), or on the portable electronic device 6 (FIG. 3), in a further embodiment of the system 100.

According to the embodiment shown in FIG. 4, in the case in which such one or more images representing the user acquirable by the electronic camera device 4 is a sequence of digital images representing the user's body movement during training, the method 40 comprises a step of providing 42 the user with information from the data processing unit 2 representing biophysical feedback on the training of the user on the gymnastic machine 1 based on the sequence of digital images representing the user's body movement.

As said above, user training is understood to mean both the training performed (that is to say performed and completed) by the user and the training in progress (that is to say being performed).

In greater detail, the aforesaid step of providing 42 the user with information representing biophysical feedback on the training performed by the user comprises a step of processing 43 by the data processing unit 2 of the sequence of digital images supplied by the electronic camera device 4.

According to another embodiment, in the case in which the training consists of running or walking on a treadmill (FIG. 1), the method 40 comprises a step of providing 44 the user, based on the sequence of digital images supplied by the electronic camera device 4, with an indication from the data processing unit 2 of the presence or not of asymmetries between the right and left sides of the body when running or walking.

According to a further embodiment, the method comprises a step of providing 45, by the data processing unit 2, based on the sequence of digital images supplied by the electronic camera device 4, information representative the time interval elapsing between two consecutive impacts of the user's feet on the treadmill, for example by means of a program code, as described above.

In another embodiment, in the step of providing 45 of the method 40 just described the data processing unit 2 may also take into account information supplied by other electronic devices (accelerometer 8, microphone 9, electronic sensor of electric current 10) which the electronic system 100 may be equipped with.

Henceforth the method 40 comprises a step of determining 46 by the data processing unit 2 based on the scroll speed of the treadmill and based on the information representative of a time interval elapsing between two consecutive impacts of the user's feet on the treadmill, the stride and/or the width of the user's step during training.

Again, the method 40 comprises a step of providing 47 the user, by the data processing unit 2 of the gymnastic machine 1, based on the frequency of the step and/or of the stride and/or of the width of the step, with an assessment of his running technique.

Such step of providing 47 the user with an assessment of his running technique may comprise the step of providing 48, by the data processing unit 2 operatively associated to the gymnastic machine 1, based on the frequency of the step, of the stride and/or of the width of the step, biophysical feedback on the correctness of the user's running or walking technique (for example indicating on a display screen 7 which the gymnastic machine 1 is fitted with, the message “correct technique” in the case of performance by the user of a natural movement compatible with the physique acquired).

The method 40 ends with a symbolic step of ending ED.

In one embodiment (not shown in FIG. 4), the method further comprises a step of determining, the data processing unit 2, based on the amplitude of the peaks of an electric signal picked up by electronic devices operatively associated to the data processing unit 2, the entity of the impact of the right foot and of the left foot on the treadmill. In addition, the method 40 comprises a step of providing the user, by the data processing unit 2, based on the entity of the impact of the right foot and of the left foot determined, as further biophysical feedback, with information representative of any asymmetries in the impact force of the user's feet on the treadmill.

Returning again to FIG. 4, in a further embodiment, in the case in which such one or more images representative of the user acquirable by the electronic camera device 4 is a digital image identifying the user, for example an image of the user's face or numerical code or alphanumerical code (as defined above), the method 40 further comprises a step of receiving 49, by the data processing unit 2, the digital image identifying the user acquired by the electronic camera device 4.

The method 40 further comprises the step of identifying 50 the user, by the data processing unit 2, based on the digital image identifying the user.

In greater detail, the step of identifying 50 comprises a step of comparing 51, by the data processing unit 2, the digital image identifying the user with the digital images stored in a database, for example integrated in the gymnastic machine 1.

According to a further embodiment, the method 40 comprises a step of comparing 52, by the data processing unit 2, the digital image identifying the user with the digital images stored in a database, for example a remote database, operatively associated, for example via Internet, to the system 100, or stored locally in the electronic system 100 (for example in the gymnastic machine 1 or in the portable electronic device 6).

At this point the method 40 ends with the symbolic step of ending ED or recommences with the method 40 described above starting from the step of acquiring 41 and the subsequent step of providing 42 the user, by the data processing unit 2, based on the sequence of digital images representative of the user's body movement, with information representing biophysical feedback of the training of the user on the gymnastic machine 1.

According to a further embodiment, to be considered alternatively or in addition to that described above, in the case in which one or more images representing the user acquirable by the electronic camera device 4 is a sequence of digital images representing the user, the method 40 comprises the step of connecting 53 the user, by the data processing unit 2, with other users in video calling, for example by means of an Internet connection via Skype.

Subsequently, the method ends with a symbolic step of ending ED or continues even concurrently with the step of connecting 53, with the method 40 described above starting from the step of acquiring 41 and the subsequent step of providing 42 the user, by the data processing unit 2, based on the sequence of digital images representative of the user's body movement, with information representing biophysical feedback on the training of the user.

It is to be noted, lastly, that a program code or product can be loaded in a memory unit in a computer, for example in the memory unit 3 of the data processing unit 2 of the system 100 (whether integrated in the gymnastic machine 1 or in the portable electronic device 6), to carry out the steps of the training method 40 according to the various embodiments described above.

As may be seen, the training system and relative method have many advantages, many of which already pointed out above, making it possible to achieve the object of the invention.

First of all it is possible for a user to perform training and have an immediate biophysical feedback regarding the quality and correctness of his posture during training (for example running style), without the need for a personal trainer to be present, thereby reducing costs for both the user and the gym.

Again, the electronic camera device (when integrated in the gymnastic machine) permits the user to identify himself or to be available for a video call even in the absence of a personal portable electronic device (smartphone or tablet) thus being able to prevent the accidental falling of such device, its misplacement or loss.

In addition, the training system enables a user to avail of functions such as user identification typically assured by a mobile phone, laptop or tablet.

In other words, the need to avail of a training system which is able to allow the user to train without necessarily foregoing the identification thereof on the gymnastic machine or the availability typically ensured by a mobile phone or lap top is satisfied.

A person skilled in the art may make modifications and variations to the embodiments of the system and relative method described above, replacing elements with others functionally equivalent so as to satisfy contingent requirements while remaining within the sphere of protection of the following claims. Each of the characteristics described as belonging to a possible embodiment may be realised independently of the other embodiments described.

1-25. (canceled)

26. A system usable by a user for training, comprising:
a data processing unit;
a memory unit operatively connected to the data processing unit;
an electronic camera device operatively associated to the data processing unit, said electronic camera device being configured to acquire one or more digital images representative of the user,
characterized in that such one or more digital images are a sequence of digital images representative of the user's body movement during training, the data processing unit being configured to provide the user, based on the sequence of digital images representative of the user's body movement during training, with information representative of a biophysical feedback of the training of the user.

27. The system according to claim 26, wherein the one or more images representative of the user further comprise a digital image of identification of the user, the data processing unit, based on the digital image of identification of the user, being further configured to identify the user.

28. The system according to claim 26, wherein such one or more digital images representative of the user further comprise a sequence of digital images representative of the user during training for the connection with other users in video calling.

29. The system according to claim 26, comprising a gymnastic machine.

30. The system according to claim 29, comprising a portable electronic device of the user associable to the gymnastic machine, the portable electronic device being associated to the data processing unit.

31. The system according to claim 30, further comprising a user interface operatively connected to the data processing unit.

32. The system according to claim 31, wherein the user interface is integrated in the gymnastic machine.

33. The system according to claim 31, wherein the user interface is integrated in the portable electronic device.

34. The system according to claim 29, wherein said electronic camera device is integrated in the gymnastic machine.

35. The system according to claim 30, wherein the electronic camera device is integrated in the portable electronic device.

36. The system according to claim 29, wherein the gymnastic machine comprises an electronic sensor of electric current, operatively associated to the data processing unit, configured to detect the electric current absorbed by an electric motor with which the gymnastic machine is provided.

37. The system according to claim 29, wherein the data processing unit is integrated in the gymnastic machine.

38. The system according to claim 30, wherein the data processing unit is integrated in the portable electronic device.

39. The system according to claim 36, wherein the gymnastic machine is a treadmill, the data processing unit being configured to determine a time interval elapsing between two consecutive impacts of the user's feet on the treadmill, on the basis of other substantially periodic signals over time, generated by the data processing unit starting from the electric signal representative of the electric current absorbed by the electric motor and detected by the electric sensor.

40. The system according to claim 26, wherein the data processing unit is configured to generate a first substantially periodic signal representative of a first deviation from a point of reference in a vertical direction in relation to a reference plane, the first deviation of the point of reference representing a first deviation in time of an upper body portion of the user in a vertical direction in relation to the reference plane.

41. The system according to claim 26, wherein the data processing unit is configured to generate a second substantially periodic signal representative of a second deviation from the point of reference in a horizontal direction in relation to a reference plane, the second deviation of the point of reference representing a second deviation in time of the upper body portion of the user in a horizontal direction in relation to the reference plane.

42. The system according to claim 26, comprising a treadmill, said biophysical feedback belonging to the group comprising: stride, width and frequency of the user's step when running or walking on the treadmill.

43. A training method of a user, comprising the steps of:
acquiring, through an electronic camera device operatively connected to a data processing unit, one or more digital images representative of the user, the one or more images representative of the user being able to be acquired by the electronic camera device being a sequence of digital images representative of the user's body movement during training;
providing the user, by the data processing unit, based on the sequence of digital images representative of the user's body movement, with information representative of a biophysical feedback of the training carried out by the user at the gymnastic machine.

44. The method according to claim 43, wherein the one or more images representative of the user acquirable by the electronic camera device are a digital image of identification of the user, the method further comprising steps of:
receiving, by the data processing unit, the digital image of identification of the user acquired by the electronic camera device;
identifying the user, by the data processing unit, based on the digital image of identification of the user.

45. The method according to claim 43, wherein such one or more images representative of the user acquirable by the electronic camera device further comprise a sequence of digital images representative of the user, the method comprising a step of connecting the user, by the data processing unit, with other users in video calling.

46. The method according to claim 43, in the case that the training consists in a running or walking on a treadmill, further comprising a step of providing the user, by the data processing unit, based on the sequence of digital images provided by the electronic camera device, with an indication of the presence or not of asymmetries between the right and left sides of the body when running or walking.

47. The method according to claim 46, further comprising a step of providing, by the data processing unit, based on the sequence of digital images provided by the electronic camera device, a piece of information representative of a time interval elapsing between two consecutive impacts of the user's feet on the treadmill.

48. The method according to claim 47, further comprising a step of determining, by the data processing unit, based on the scroll speed of the treadmill and based on the piece of representative information of a time interval elapsing between two consecutive impacts of the user's feet on the treadmill, the stride and/or the width of the user's step during training.

49. The method according to claim 48, further comprising a step of providing the user, by the data processing unit of the gymnastic machine, based on at least one of the time interval elapsing between two consecutive impacts of the user's feet on the treadmill, the stride and the width of the step, with an assessment of his/her running technique.

50. A program product loadable in a memory unit of an electronic calculator to carry out the steps of the training method in accordance with claim 43.
